(19) United States
(12) Patent Application Publication
(10) Pub. No.: US 2014/0164136 A1
(43) Pub. Date: Jun. 12, 2014

(54) BROAD MATCHING ALGORITHM FOR DISPLAY ADVERTISEMENTS

(71) Applicant: Linkedln Corporation, Mountain View, CA (US)

(72) Inventors: Christian Posse, Foster City, CA (US); Deepak Agarwal, Sunnyvale, CA (US); Anmol Bhasin, Mountain View, CA (US); Ashvin Kannan, Sunnyvale, CA (US); Jonathan David Traupman, Oakland, CA (US); Gyanda Sachdeva, Mountain View, CA (US)

(73) Assignee: LinkedIn Corporation, Mountain View, CA (US)

(21) Appl. No.: 13/707,530

(22) Filed: Dec. 6, 2012

(51) Int. Cl. G06Q 30/02

(52) U.S. Cl. CPC G06Q 30/0269
USPC 705/14.66

(57) ABSTRACT

A method of matching advertisements to users is disclosed. A plurality of attributes of a population of users is identified. A selection is received of an attribute of the plurality of attributes to which a target value is to be broadly matched. A correspondence of an advertisement to a user is determined based on a broad matching of the target value to the attribute. The advertisement is matched to the user based at least in part on the determining of the correspondence.

### TECHNICAL FIELD

This application relates generally to the technical field of internet advertising and, in one specific example, to placing an advertisement in a content page that is to be displayed to a user based on broad matching of a target value specified by an advertiser to an attribute associated with a population of users.

### BACKGROUND

An owner of a system that serves content to users (e.g., a web site, such as Google.com, Facebook.com, Youtube.com, Yahoo.com, Amazon.com, or Linkedin.com) may sell advertising space to advertisers. For example, Google.com may allow advertisers to bid for advertising space on a content page (e.g., through Google AdSense). The system may then rank advertisements available for displaying in the advertising space based on various factors such as tie amount of the bid, the quality of the advertisement (e.g., a performance of the advertisement on the system or a relevancy of the advertisement to keywords entered by a user), and so on. Then the system may select a subset of the advertisements (e.g., the top 3) for presenting in the advertising space. Thus, the selected advertisements may be considered to be winners of an advertising auction for the available advertising space. Alternatively, the system may allow advertisers to pay for guaranteed placement on an advertising space on the content page (e.g., without having to compete with bids in an auction).

### BRIEF DESCRIPTION OF THE DRAWINGS

Some embodiments are illustrated by way of example and not limitation in the figures of the accompanying drawings in which:

FIG. 1 is a network diagram depicting a client-server system within which various example embodiments may be deployed;

FIG. 2 is a block diagram illustrating example modules of the application(s) of FIG. 1;

FIG. 3 is a flow chart illustrating an example embodiment of a method of selecting an advertisement for presentation to a user;

FIG. 4 is a flow chart illustrating an example embodiment of a method of selecting an advertisement for presentation to a user;

FIG. 5 is a flow chart illustrating an example embodiment o a method of discounting bids based on a degree of broad matching;

FIG. 6 is a flow chart illustrating an example embodiment of a method of reducing a. charge for presenting an advertisement to a user based on a conversion rate of the advertisement;

FIG. 7 is a flow chart illustrating an example embodiment of a method of using broad matching as a tool for demonstrating to advertisers the utility of making their targeting less specific;

FIG. 8 is a flow chart illustrating an example embodiment of a method of placing online advertisements; and

FIG. 9 is a block diagram of a machine in the example form of a computer system within which instructions for causing the machine to perform any one or more of the methodologies discussed herein may be executed.

### DETAILED DESCRIPTION

In the following description, for purposes of explanation, numerous specific details are set forth in order to provide an understanding of various embodiments of the inventive subject matter. It will be evident, however, to those skilled in the art that embodiments may be practiced without these specific details. Further, to avoid obscuring the inventive concepts in unnecessary detail, well-known instruction instances, protocols, structures, and techniques have not been shown in detail. As used herein, the term “or” may be construed in an inclusive or exclusive sense, the term “user” may be construed to include a person or a machine, and the term “interface” may be construed to include an application program interface (API) or a user interface.

In various embodiments, a method of matching advertisements to users is disclosed. A plurality of attributes of a population of users is identified. A selection is received of an attribute of the plurality of attributes to which a target value is to be broadly matched. A correspondence of an advertisement to a user is determined based on a broad matching of the target value to the attribute. The advertisement is selected for presentation to the user based at least in part on the determining of the correspondence.

In various embodiments, a method of matching users to advertisements is disclosed. An accessing of content by a user is identified. An advertisement is selected for presentation to the user in conjunction with the content based at least in part on a broad matching of a value of an attribute of the user with a target value.

In various embodiments, a user with several (possibly hundreds) of attributes having particular values visits the site. At some point a call is made to networked system to get a set of advertisement candidates from which a subset of advertisements will be selected tier presentation to the user.

When exact matching is employed, the system may look through its database of advertisements and find candidates that are targeted at combinations of attribute values that occur on that user. For example, the system may target users having attributes (A=1, =3, D=9). In this case, an advertisement targeting users having attributes (A=1, D=9) will be considered a match, but an advertisement targeting users having attributes (A=2, B=3) will not be considered a match.

On the other hand, when broad matching is employed, the system may also return advertisements targeting sets of attributes and values that do not exactly match the specific attributes and values that were specified (e.g., by an advertiser). Attributes can be broadened in many ways: For example, an attribute value specifying to a specific city may be broadened to a metro region or a specific job title may be broadened to a more general one (e.g. “senior executive vice president” to “vice president”). Attribute values may be broadened to a set of values that are determined to be behaviorally similar even if there is no obvious superficial semantic relationship. For example, if the system deter nines that for attribute A, values 1 and 2 are similar in some sense, then a user with attributes (A=1, B=3, D=9) will now broadly match (A=2, B=3), whereas, with exact matching, the user would not match (A=2, B=3).

In various embodiments, the attribute values specified with respect to the user may be broadened, the target values for the advertisement (e.g., as specified by the advertiser) may be broadened, or both. An intersection between the attribute values of the user and the target values is then determined (e.g., mathematically by an algorithm).

The degree to which broadening is employed may be used by subsequent processing that determines whether to pick an ad from a set of candidates. For example, the system may prefer to run exactly-matched advertisements more or less than broadly matched advertisements. To facilitate this, during the broadening, the system may attach weights to describe how closely related two attributes are. For example, broadening “senior software engineer” to “software engineer” may be considered less of a stretch than broadening it to “programmer” or “IT”. In various embodiments, the weight of the broadening may not play much of a role in the candidate selection phase, but may be important when choosing a candidate to show.

These methods and other methods or embodiments disclosed herein may be implemented as a computer system having one or more modules (e.g., hardware modules or software modules). These methods and other methods or embodiments disclosed herein may be embodied as instructions stored on a machine-readable medium that, when executed by a processor, cause the processor to perform the method.

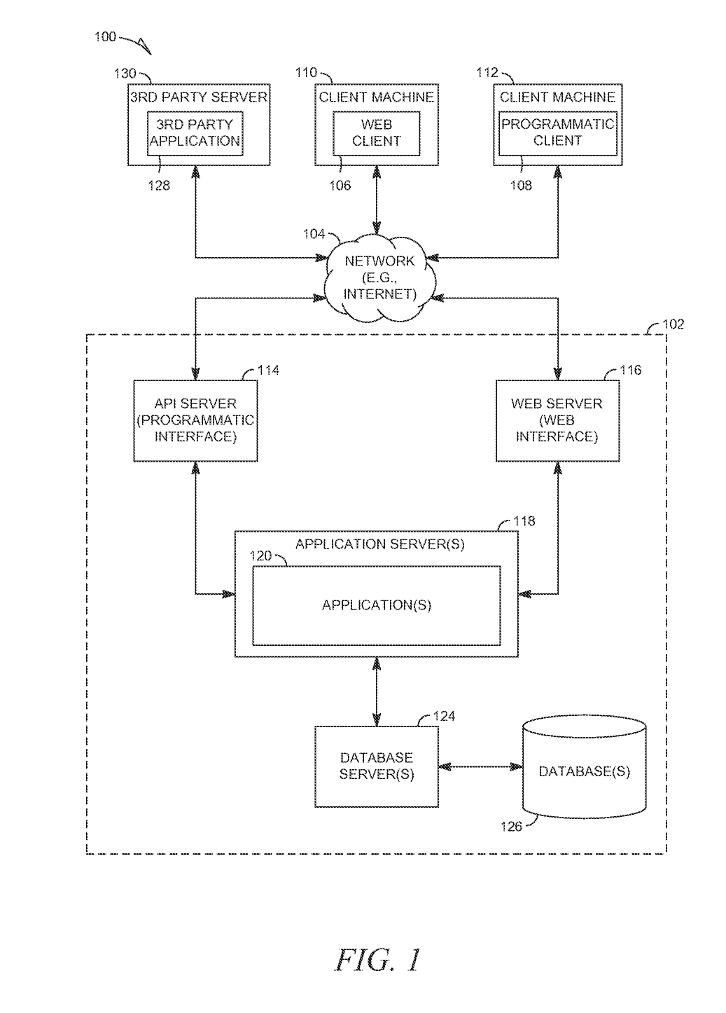

FIG. 1 is a network diagram depicting a client-server system 100, within which various example embodiments may be deployed. A networked system 102, in the example forms of a network-based social-networking site or other communication system, provides server-side functionality, via a network 104 (e.g., the Internet or Wide Area Network (WAN)) to one or more clients. FIG. 1 illustrates, for example, a web client 106 (e.g., a browser, such as the Internet Explorer browser developed by Microsoft Corporation of Redmond, Wash.) and a programmatic client 108 executing on respective client machines 110 and 112. Each of the one or more clients 106, 108 may include a software application module (e.g., a plug-in., add-in, or macro) that adds a specific service or feature to a larger system.

An API server 114 and a web server 116 are coupled to, and provide programmatic and web interfaces respectively to, one or more application servers 118. The application servers 118 host one or more applications 120. The application servers 118 are, in turn, shown to be coupled to one or more databases servers 124 that facilitate access to one or more databases or NoSQL or non-relational data stores 126.

The applications 120 may provide a number of functions and services to users who access the networked system 102. While the applications 120 are shown in FIG. 1 to form part of the networked system 102, in alternative embodiments, the applications 120 may form part of a service that is separate and distinct from the networked system 102.

Further, while the system 100 shown in FIG. 1 employs a client-server architecture, various embodiments are, of course, not limited to such an architecture, and could equally well find application in a distributed, or peer-to-peer, architecture system, for example. The various applications 120 could also be implemented as standalone software programs, which do not necessarily have computer networking capabilities. Additionally, although FIG. 1 depicts machines 130,110, and 112 as being coupled to a single networked system 102, it will be readily apparent to one Skilled in the art that machines 130, 110, and 112, as well as client 128, 106, and 108, may be coupled to multiple networked systems. For example, the clients 128, 106, and 108 may be coupled to multiple applications 120, such as payment applications associated with multiple payment processors (e.g., Visa, MasterCard, and American Express).

The web client 106 accesses the various applications 120 via the web interface supported by the web server 116. Similarly, the programmatic client 108 accesses the various services and functions provided by the applications 120 via the programmatic interface provided by the API server 114. The programmatic client 108 may, for example, perform batch-mode communications between the programmatic client 108 and the networked system 102.

FIG. 1 also illustrates a third party application 128, executing on a third party server machine 130, as having programmatic access to the networked system 102 via the programmatic interface provided by the API server 114, For example, the third party application 128 may, utilizing information retrieved from the networked system 102, support one or more features or functions on a website hosted by the third party The third party website may, for example, provide one or more promotional, social-networking, or payment functions that are supported by the relevant applications of the networked system 102.

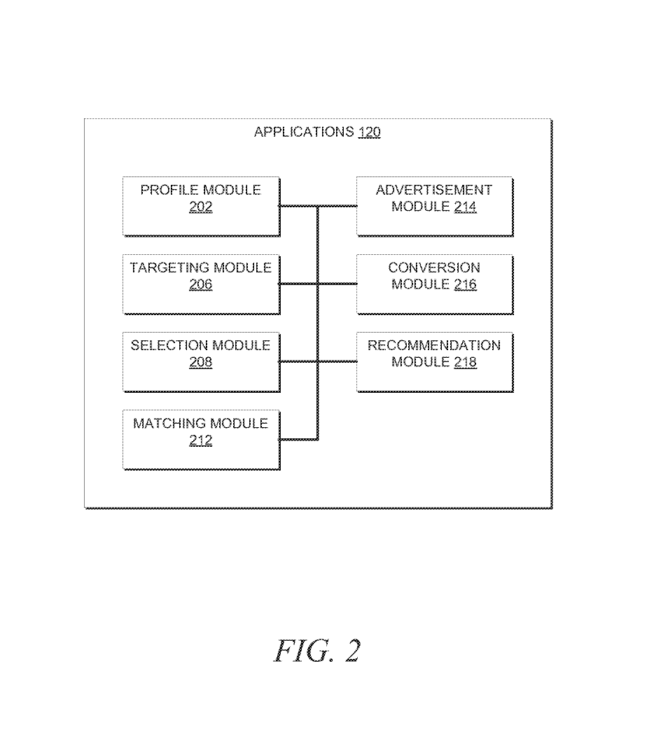

FIG. 2 is a block diagram illustrating example modules of the application(s) 120 of FIG. 1. A profile module 202 is configured to maintain or provide access to profiles of users of the system 101. A targeting module 206 is configured to receive a specification of information about users that advertisements are to target. A selection module 208 is configured to select one or more advertisements from a set of advertisements for presentation to a user (e.g., advertising space on a content page that is to be presented to the user) or select one or more users from a set of users to which an advertisement is to be presented. A matching module 212 matches advertisement to users based on various criteria, such as an intersection between values of attributes of the users and advertisement target values. An advertising module 214 is configured to place advertisements (e.g., in an advertising space) based on various criteria, such as a winning of an advertising auction for an advertising space or a purchasing of advertising space by an advertiser. A conversion module 216 is configured to determine a conversion rate of an advertisement based on various criteria, such as whether the advertisement was placed based on exact matching or a broad matching of a value of an attribute of a user to a target value associated with an advertisement. The conversion rate may be the rate at which users perform a desired action upon being presented with the advertisement in an advertising space on content pages presented to the users. For example, the conversion rate may be the rate at which users click on the advertisement to visit a web page associated with the advertiser who placed the advertisement. Or the conversion rate may be the rate at which users purchase a product on a web site associated with the advertiser. A recommendation module 218 is configured to make recommendations, such as a recommendation that an advertiser should increase a bid for an advertisement that uses abroad matching algorithm.

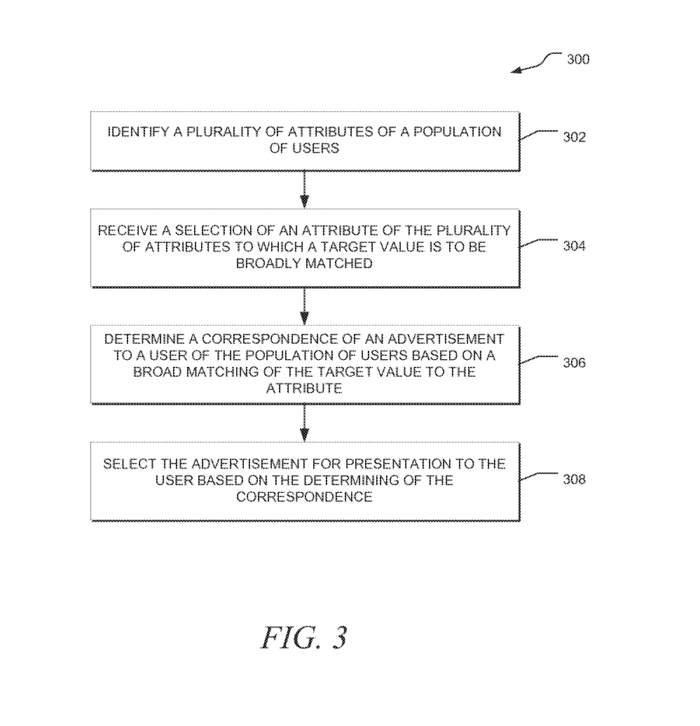

FIG. 3 is a flow chart illustrating an example embodiment of a method 300 of selecting an advertisement for presentation to a user. In various embodiments, the method 300 is implemented by application(s) 120. At operation 302, the profile module 202 identifies a plurality of attributes of a population of users. For example, on a professional networking system, such as LinkedIn, such attributes of the population of users may include professional headline, location, industry, current job title, current employer, past job titles, past employers, work experience, skills and expertise, education, interests, affiliations (e.g., with groups and associations), honors, awards, personal information (phone number, address, email address, instant messenger address, twitter name, birthday, marital status), contact preferences, favorite web sites, and so on.

At operation 304, the targeting module 206 receives a selection of an attribute of the plurality of attributes to which a target value is to be applied. For example, the targeting module 206 may receive a specification from an advertiser that an advertisement is to be targeted at users having a current job title or a past job title of “Software Engineer.” Additionally, the targeting module 206 may receive a specification from the advertiser that a broad matching algorithm is to be applied when the system searches for users having a current job title or a past job title of “Software Engineer.” The targeting module 206 may use matching algorithms of various breadths (or a single matching algorithm having a configurable breadth) to identify matches between an advertisement and a target user (e.g., a user to whom the advertiser wants to show the advertisement).

For example, an exact matching algorithm may provide only exact matches (e.g., only users that have a current title or past title that is exactly “Software Engineer”) or, in various embodiments, the exact matching algorithm may provide exact matches and very close variants, such as abbreviations or case-insensitive matches (e.g., only users that have a current title or past title of “Software Engineer,” “Software Engr.,” “software engineer,” and so on).

A broad matching algorithm, on the other hand, may include synonyms, related terms, relevant variations of terms or related terms, phrases, close variants of phrases, and so on. For example, an application of a broad matching algorithm to users having a current title or past title of “Software Engineer” may identify users having a current title or past title of “Software Engineering Manager,” “SW Engineer,” and so on. Furthermore, a broad matching algorithm may identify a user having a completely different current title or past title (e.g., “Information Technologist”) based on, for example, strengths of similarities between the user and additional users that identify themselves as “Software Engineers,” as described in more detail below.

In various embodiments, the targeting module 206 may allow advertisers to control the breadth of the matching of advertisements to users (e.g., the bread of one or more algorithms that are applied). For example, in various embodiments, there may be a finite set of identified attributes of a population of users. Additionally, each of the finite set of identified attributes may have a finite set of possible values. The advertiser may be allowed to specify modifications to the broad matching algorithm to include or exclude individual ones of the finite set of possible values for each of the finite set of attributes. For example, the advertiser may be allowed to specify that advertisements should not be targeted to users that have a current title or past title of “Information Technologist,” or that the advertisements should not be targeted to users who do not have at least a Bachelor's degree, even if the results of an application of the broad matching algorithm suggest otherwise.

At operation 306, the matching module 212 determines a correspondence of an advertisement to a user of the population of users based on a target value broadly matching an attribute of the user. For example, based on input that an advertisement is to be targeted to users of the population having a current title or past title of “Software Engineer,” the broad matching algorithm may identify that a user having a past job title of “Information Technologist” is likely to be a desired target of the advertiser regardless of whether a current or past job title of the user is “Software Engineer.” Or the broad matching algorithm may identify that a user having past title of “Software Engineer” is a broad match for users having a current title of “Software Engineer,” even if the user does not have a current title of “Software Engineer.”

At operation 308, the selection module 208 selects the advertisement for presentation to the user. For example, the selection module 208 determines that a bid submitted by the advertiser is sufficient for the advertisement to win an auction for advertising space on a content page that is to be presented to the user or that the advertisement is particularly relevant to the user based on a context in which the user accesses a content page on which the advertisement is to be displayed.

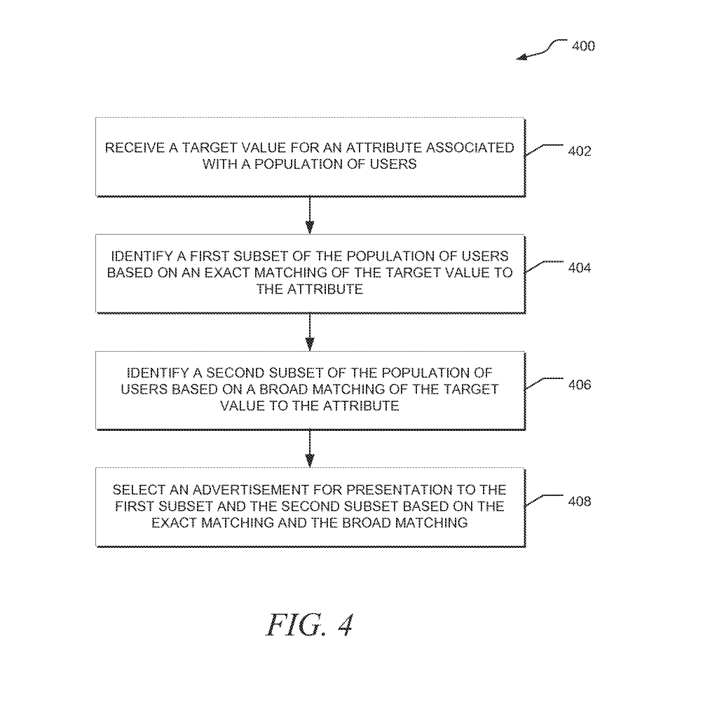

FIG. 4 is a flow chart illustrating an example embodiment of a method 400 of selecting a set of users to whom an advertisement is to be presented. In various embodiments, the method 400 is implemented by application(s) 120. At operation 402, the matching module 212 receives a target value for an attribute associated with a population of users. For example, the matching module 212 may receive an indication from an advertiser that users who are to be a target for an advertisement are users that have a current title attribute of “Software Engineer.” Or the matching module 212 may determine the target value based on an analysis of the advertisement (e.g., keywords, context, or other information derived from the advertisement itself).

At operation 404, the matching module 212 identifies a first subset of the population of users based on an exact matching of the target value to the attribute. For example, the matching module 212 identifies a first subset of the population of users that each have a current title attribute that is exactly “Software Engineer.” Or, in some embodiments, the matching module 212 identifies a first subset of users that each have a current title attribute of “Software Engineer” or a close variant.

At operation 406, the matching module 212 identifies a second subset of the population of users based on a broad matching of the target value to the attribute. For example, the matching module 212 identifies a second subset of the population of users that have a past title attribute that exactly matches “Software Engineer” even though the users do not have a current title attribute that matches “Software Engineer.” Or the matching module 212 identifies a second subset of users based on the second set of users having a value for a different attribute (e.g., a college degree title attribute) that is shared by the first subset of users. For example, the matching module 212 identifies a second set of users that, like the first subset of users, have a college degree attribute containing “Computer Science,” even though the second set of users do not have a current title that exactly matches “Software Engineer.” Or, as another example, the matching module 212 identifies a second subset of users based on them exhibiting similar behavior with respect to the system (e.g., accessing articles pertaining to the same subjects, connecting to similar types of people, and so on) as the first set of users, even though the second set of users do not have a value for the selected attribute that exactly matches the target value.

At operation 408, the selection module 208 selects the advertisement for presentation to the first subset and the second subset based on the exact matching and the broad matching. In various embodiments, whether the advertisement is presented to the second subset of the population of users may be based on whether the advertiser specified that broad matching is to be used for the selected attribute and the target value.

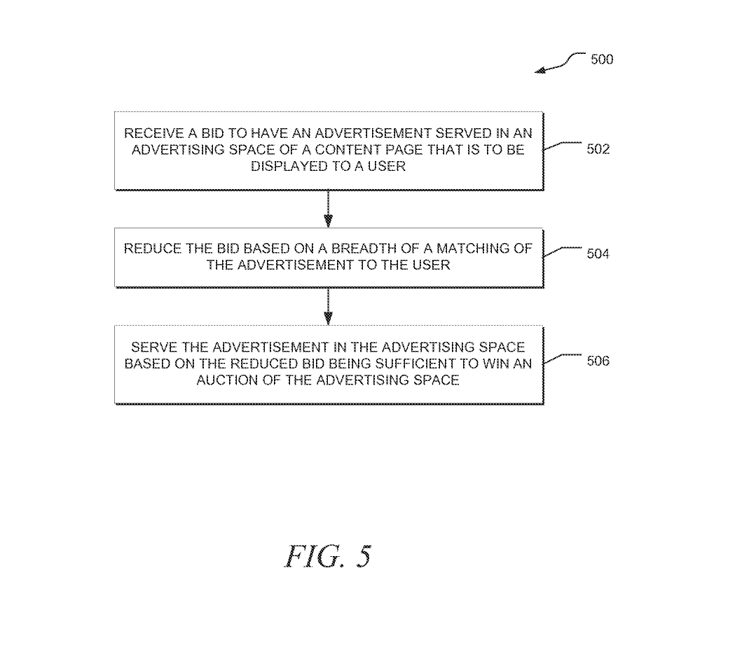

FIG. 5 is a flow chart illustrating an example embodiment of a method 500 of discounting bids based on a degree of broad matching. In various embodiments, the method 500 is implemented by application(s) 120. At operation 502, the advertisement module 214 receives a bid to have an advertisement served in an advertising space of a content page that is to be displayed to a user. For example, the advertiser may specify that the advertiser will pay a maximum of $2 each time a user clicks on the advertisement.

At operation 504, the advertisement module 214 reduces the bid based on a breadth of a matching of the advertisement to the user. For example, if a matching score between the advertisement and the user is a 10 on a scale of 1 to 10 (with 10 being the broadest match and 1 being the narrowest match), the advertisement module 214 may reduce the received bid by a percentage e.g., 90%). Thus, an advertiser who elects broad matching of advertisements to users may have their bids for advertising space on a content page that is to be served to a user automatically scaled down based on the breadth of the matching. For example, if the system determines that a user having a past title of “Information Technologist” matches the advertiser's desired target value of “Software Engineer” for the user's current title, the system may reduce the advertiser's bid based on the match being relatively broad (e.g., in comparison to matches of other current and past titles of the user or additional users). In various embodiments, a matching score is associated with a value for an attribute that is used in place of a target value for the attribute in order to broaden a matching of an advertisement to a user. The matching score may be based on various factors, such as a closeness of the substituted value to the target value or a conversion rate of users for which the substituted value is used in place of the target value. For example, if a target value for the current title attribute of a user is “Software Engineer,” the matching score for “Computer Engineer” may be high relative to a matching score for “Information Technologist” based on, for example, the conversion rate of users having various values of the current title attribute to which the advertising has been presented. In various embodiments, the breadth of the broad matching may be based on the broadening of values of attributes of the user, the broadening of values specified as target attributes for an advertisement, or both. Thus, the method 500 may be applied to either the case of selecting users for an advertisement or the case of selecting advertisements for a user.

At operation 506, the advertisement module 214 serves the advertisement to the user (e.g., based on the reduced bid being sufficient for the advertiser to win an auction of the advertising space on a content page that is to be served to the user).

Method 500 illustrates bid discounting as a way to use degree of broad matching as an input to ranking and advertisement selection. However, it should be understood that the degree of broad matching may be incorporated into the matching algorithm used by the advertisement module 214 independently of bid discounting. For example, in a non-auction-style advertising system, the advertisement module 214 may give a higher priority to advertisements having exact matches to the user in comparison to advertisements having broad matches to the user.

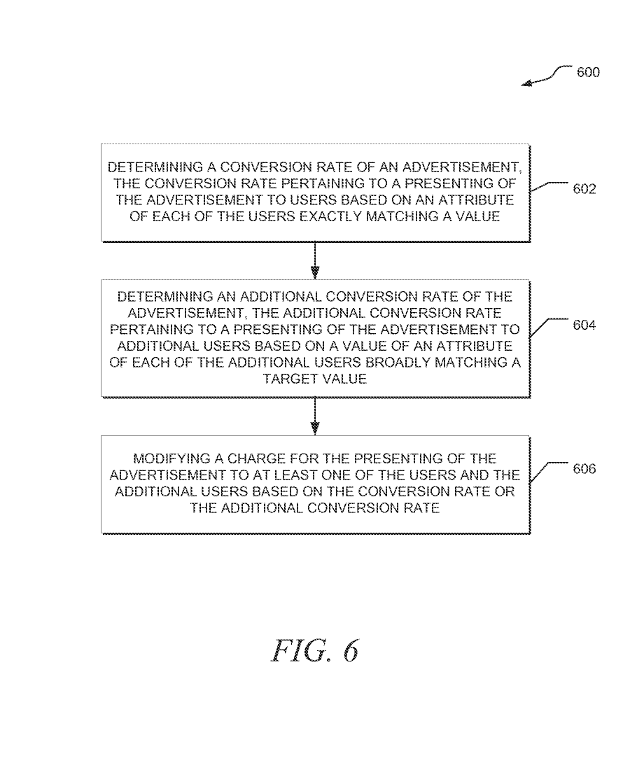

FIG. 6 is a flow chart illustrating an example embodiment of a method 600 of reducing a charge for presenting an advertisement to a user based on a conversion rate of the advertisement. In various embodiments, the method 600 is implemented by application(s) 120. At operation 602, the conversion module 216 determines a conversion rate of an advertisement. Here, the conversion rate pertains to a presenting of the advertisement to a user based on an attribute of the user exactly matching a value.

At operation 604, the conversion module 216 determines an additional conversion rate of the advertisement. Here, the additional conversion rate pertains to a presenting of the advertisement to additional users based on a degree to which a value of an attribute of an additional user that broadly matching a target value. In various embodiments, each user in the set of additional users identified through broad matching may have a different value to the advertiser based on a predicted conversion rate of the user).

At operation 606, the advertisement module 214 modifies a charge for the presenting of the advertisement to at least one of the users and the additional users based on the conversion rate or the additional conversion rate. Thus, in various embodiments, if a user is presented with an advertisement based on a broad match, the bid for that advertisement is reduced based on how less often this user will convert compared to a baseline conversion rate of users of the exact-match population. Furthermore, a second user who is broad matched to the same advertisement may have a different bid reduction applied if the predicted conversion rate for that user in comparison exact-match population is different from the first user.

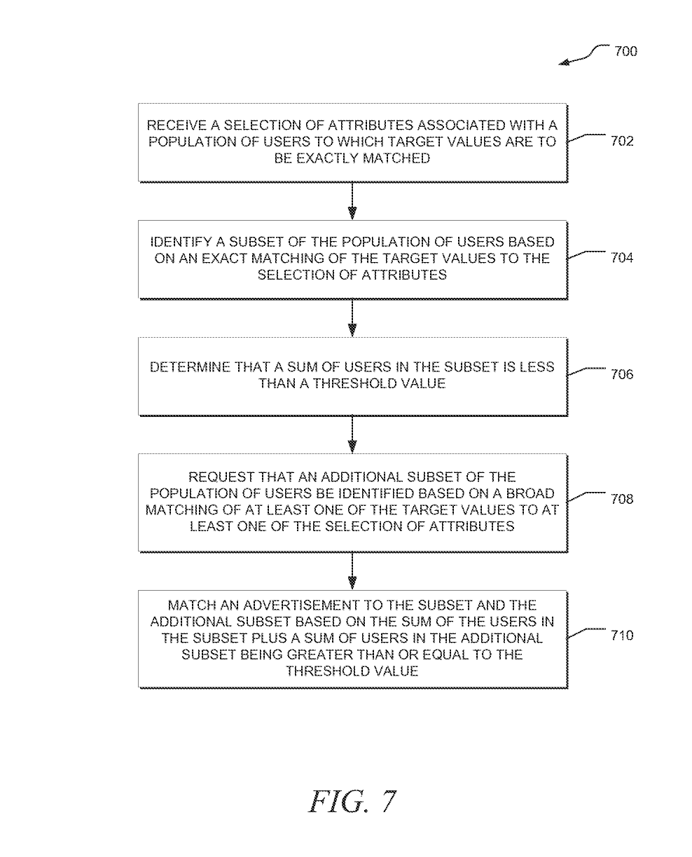

FIG. 7 is a flow chart illustrating an example embodiment of a method 700 of using broad matching as a tool for demonstrating to advertisers the utility of making their targeting less specific. At operation 702, the selection module 202 receives a selection of attributes associated with a population of user to which target values are to be exactly matched. In various embodiments, as indicated above, an “exact match” may include the target value exactly as it is specified by the advertiser as well as close variants of the target value.

At operation 704, the targeting module 206 may identify a subset of the users of the population of users based on an exact matching of the target values to the selection of attributes. For example, if the advertiser specifies that desired users are users having a current title attribute that is “Software Engineer” and a degree attribute that is “Bachelor of Computer Science,” the targeting module 206 may identify the subset of the users that have that current title and that degree (and, in some cases users that have close variants of that current title and that degree).

At operation 706, the advertisement module 214 may identify that a sum of the users in the subset is less than a threshold value. For example, the advertisement module may determine that the number of the users having the desired attributes is less than a predetermined threshold value (e.g., 10,000) for which the presentation of the advertising to the users is to be allowed.

At operation 708, the advertisement module 214 may request that an additional subset of the population of users be identified based on a broad matching of at least one of the target values to at least one of the selection attributes. For example, the advertisement module 214 may request that an advertiser allow the system to broadly match a target value to a selected attribute to potentially increase the sum of the population of users above the threshold value.

At operation 710, the advertisement module 214 matches an advertisement to the subset and the additional subset of the population of users based on the sum of the users in the subset plus the sum of the users in the additional subset being greater than or equal to the threshold value.

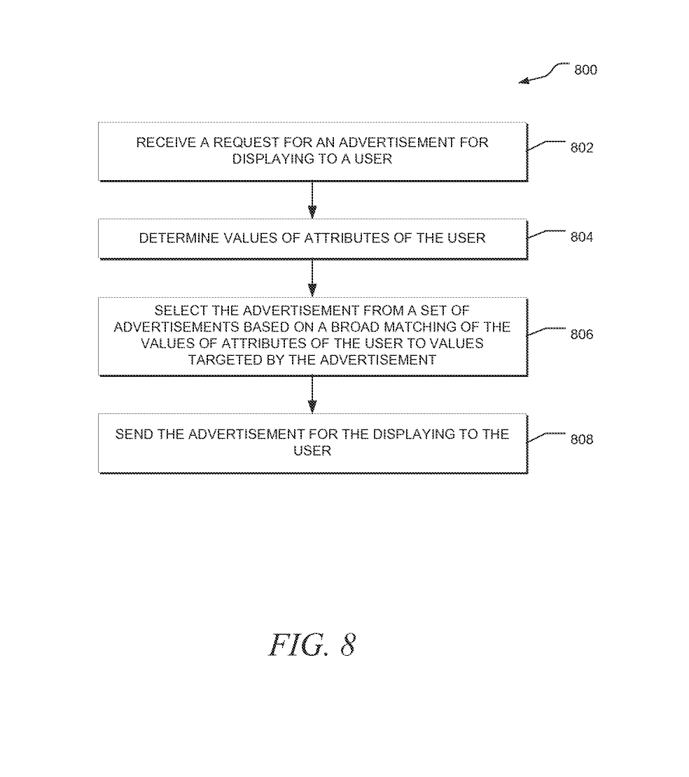

FIG. 8 is a flow chart illustrating an example embodiment of a method 800 of selecting an advertisement for presenting o a user. In various embodiments, the method 800 is implemented by application(s) 120. At operation 802, the selection module 206 receives a request for an advertisement for displaying to a user. For example, the selection module 206 receives an indication that a user has accessed content hosted on a web site of the system 102 that has associated advertising space.

At operation 804, the profile module 202 determines values of attributes of the user. For example, the profile module 202 determines that the user has a job title of “Software Architect” and a degree of “Bachelor of Science in Software Engineering.”

At operation 806, the selection module 206 selects the advertisement from a set of advertisements based on a broad matching of the values of attributes of the user to values targeted by the advertisement. For example, the selection module 206 makes a determination based on an application of a broad matching algorithm that the title attribute of the user, which is specified as “Software Architect,” intersects with a target value of the advertisement, which is specified as “Software Engineer,” The broadening of “Software Engineer” to “Engineer” for the job title may be based on an identification of similarities between the user and additional users who have a job title of “Software Engineer.” Such similarities may be based on similarities between attribute values of the user and the additional users or behaviors of the user in comparison to behaviors of the additional users with respect to the system (e.g., a browsing of articles of the same subject on the system, a viewing of the same job opportunities on the system, and so on).

At operation 808, the advertisement module 214 sends the advertisement for displaying to the user. Thus, the upon accessing the content on the system, the user is presented with the advertisement in the advertising associated with the content based on broad matching of the advertisement to the values of the attributes of the user.

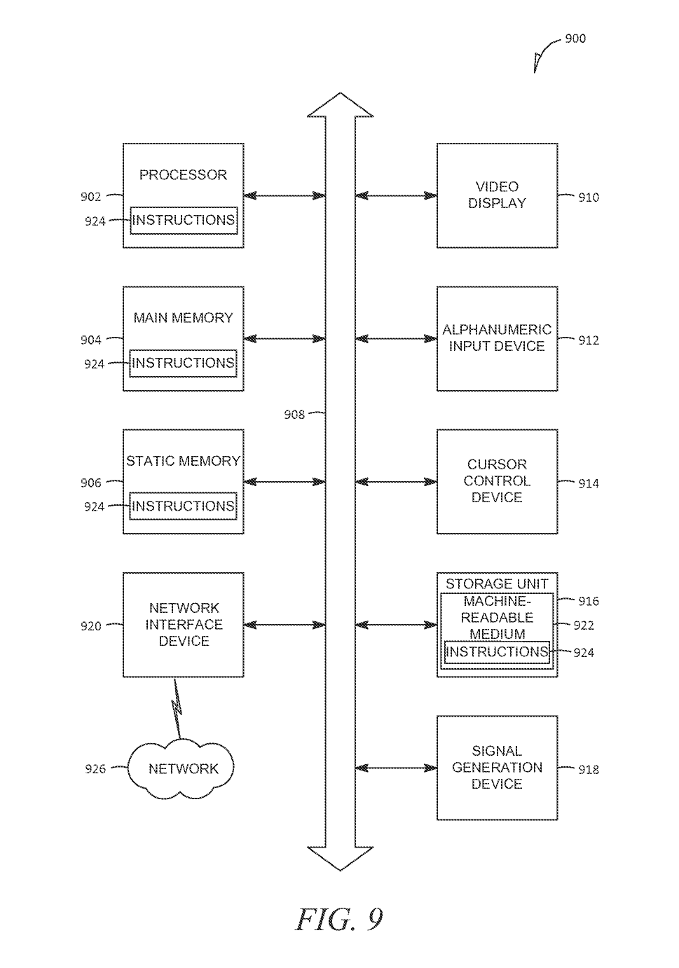

FIG. 9 is a block diagram of a machine in the example form of a computer system 900 within which instructions for causing the machine to perform any one or more of the methodologies discussed herein may be executed. In alternative embodiments, the machine operates as a standalone device or may be connected (e.g., networked) to other machines. In a networked deployment, the machine may operate in the capacity of a server or a client machine in a server-client network environment, or as a peer machine in a peer-to-peer (or distributed) network environment. The machine may be a personal computer (PC), a tablet PC, a set-top box (STB), a personal digital assistant (PDA), a cellular telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 900 includes a processor 902 (e.g., a central processing unit (CPU), a graphics processing unit (GPU) or both), a main memory 904 and a static memory 906, which communicate with each other via a bus 908. The computer system 900 may further include a video display unit 910 (e.g., a liquid crystal display (LCD) or a cathode ray tube (CRT)). The computer system 900 also includes an alphanumeric input device 912 (e.g., a keyboard), a user interface navigation (or cursor control) device 914 (e.g., a mouse), a storage unit 916, a signal generation device 918 (e.g., a speaker), and a network interface device 920.

The disk drive unit 916 includes a machine-readable medium 922 on which is stored one or more sets of data structures and instructions 924 (e.g., software) embodying or utilized by any one or more of the methodologies or functions described herein. The instructions 924 may also reside, completely or at least partially, within the main memory 904 and/or within the processor 902 during execution thereof by the computer system 900, with the main memory 904 and the processor 902 also constituting machine-readable media. The instructions 924 may also reside, completely or at least partially, within the static memory 906.

While the machine-readable medium 922 is shown in an example embodiment to be a single medium, the term “machine-readable medium” may include a single medium or multiple media (e.g., a centralized or distributed database, and/or associated caches and servers) that store the one or more instructions or data structures. The term “machine-readable medium” shall also be taken to include any tangible medium that is capable of storing, encoding or carrying instructions for execution by the machine and that cause the machine to perform any one or more of the methodologies of the present embodiments, or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including by way of example semiconductor memory devices, e.g., Erasable Programmable Read-Only Memory (EPROM), Electrically Erasable Programmable Read-Only Memory (EEPROM), and flash memory devices; magnetic disks such as internal hard disks and removable disks; magneto-optical disks; and compact disc-read-only memory (CD-ROM) and digital versatile disc or digital video disc) read-only memory (DVD-ROM) disks.

The instructions 924 may further be transmitted or received over a communications network 926 using a transmission medium. The network 926 may correspond to the network 104. The instructions 924 may be transmitted using the network interface device 920 and any one of a number of well-known transfer protocols (e.g., Hyper Text Transfer Protocol (HTTP)). Examples of communication networks include a local area network (LAN), a WAN”, the Internet, mobile telephone networks, Plain Old Telephone (POTS) networks, and wireless data networks (e.g., WiFi and WiMax networks). The term “transmission medium” shall be taken to include any intangible medium that is capable of storing, encoding or carrying instructions for execution by the machine, and includes digital or analog communications signals or other intangible media to facilitate communication of such software.

Although an embodiment has been described with reference to specific example embodiments, it will be evident that various modifications and changes may be made to these embodiments without departing from the broader spirit and scope of the invention. Accordingly, the specification and drawings are to be regarded in an illustrative rather than a restrictive sense. The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

What is claimed is:

1. A method comprising:
identifying a plurality of attributes of a population of users;
receiving a selection of an attribute of the plurality of attributes to which a target value is to be broadly matched;
determining a correspondence of an advertisement to a user based on a broad matching of the target value to the attribute, the determining of the correspondence being performed by at least one processor; and
matching the advertisement to the user based at least in part on the determining of the correspondence.

2. The method of claim 1, wherein the target value is selected from a set of target values associated with the attribute.

3. The method of claim 2, wherein the broad matching of the target value to the attribute is based on a similarity between the user and a set of additional users, the set of additional users identified based on an exact matching of the target value to the attribute.

4. The method of claim 3, wherein the similarity is based on a matching score of an additional target value to an additional attribute.

5. The method of claim 1, further comprising reducing a bid for advertising space in which the presentation of the advertisement is to occur based on a degree of the broad matching of the target value to the attribute.

6. The method of claim 1, further comprising modifying a charge for the presentation of the advertisement based on an expected conversion rate of the user, the expected conversion rate being based on a breadth of the broad matching.

7. The method of claim 1, wherein the determining of the correspondence and the selecting of the advertisement are performed in response to a user accessing content on a web site having an advertising space for the presentation of the advertisement to the user.

8. A system comprising:
a processor-implemented module configured to:
identify a plurality of attributes of a population of users;
receive a selection of an attribute of the plurality of attributes to which a target value is to be broadly matched;
determine a correspondence of an advertisement to a user based on a broad matching of the target value to the attribute; and
matching the advertisement to the user based at least in part on he determining of the correspondence.

9. The system of claim 8, wherein the target value is selected from a set of target values associated with the attribute.

10. The system of claim 9, wherein the broad matching of the target value to the attribute is based on a similarity between the user and a set of additional users, the set of additional users identified based on an exact matching of the target value to the attribute.

11. The system of claim 10, wherein the similarity is based on a matching score of an additional target value to an additional attribute.

12. The system of claim 8, wherein the processor-implemented module is further configured to reduce a bid for advertising space in which the presentation of the advertisement is to occur based on a degree of the broad matching of the target value to the attribute.

13. The system of claim 8, wherein the processor-implemented module is further configured to modify a charge for the presentation of the advertisement based on an expected conversion rate of the user, the expected conversion rate being based on a breadth of the broad matching.

14. The system of claim 8, wherein the determining of the correspondence and the selecting of the advertisement are performed in response to a user accessing content on a web site having an advertising space for the presentation of the advertisement to the user.

15. A non-transitory machine readable medium embodying a set of instructions that, when executed by a processor, cause the processor to perform operations, the operations comprising:
identifying a plurality of attributes of a population of users;
receiving a selection of an attribute of the plurality of attributes to which a target value is to be broadly matched;
determining a correspondence of an advertisement to a user based on a broad matching of the target value to the attribute; and
matching the advertisement to the user based at least in part on he determining of the correspondence.

16. The non-transitory machine readable medium of claim 15, wherein the target value is selected from a set of target values associated with the attribute.

17. The non-transitory machine readable medium of claim 16, wherein the broad matching of the target value to the attribute is based on a similarity between the user and a set of additional users, the set of additional users identified based on an exact matching of the target value to the attribute.

18. The non-transitory machine readable medium of claim 17, wherein the similarity is based on a matching score of an additional target value to an additional attribute.

19. The non-transitory machine readable medium of claim 15, further comprising reducing a bid for advertising space in which the presentation of the advertisement is to occur based on a degree of the broad matching of the target value to the attribute.

20. The non-transitory machine readable medium of claim 15, further comprising modifying a charge for the presentation of the advertisement based on an expected conversion rate of the user, the expected conversion rate being based on a breadth of the broad matching.
